(19) United States
(12) Patent Application Publication
(10) Pub. No.: US 2023/0048791 A1
(43) Pub. Date: Feb. 16, 2023

(54) Rail system

(71) Applicants: Kerry Hayes, Broadbeach Waters (AU); Robert Kenneth Campbell, Broadbeach Waters (AU)

(72) Inventors: Kerry Hayes, Broadbeach Waters (AU); Robert Kenneth Campbell, Broadbeach Waters (AU)

(21) Appl. No.: 17/796,027

(22) PCT Filed: Jan. 29, 2021
(86) PCT No.: PCT/AU21/50065

§ 371 Date: Jul. 28, 2022

(30) Foreign Application Priority Data
Feb. 1, 2020 (AU) 2020100168

(51) Int. Cl. E06B 9/58; E05F 15/676; E06B 9/68; E05F 5/06

(52) U.S. Cl. CPC E06B 9/58; E05F 15/676; E06B 9/68; E05F 5/06; E05Y 2900/132

(57) ABSTRACT

A rail system comprises: a guide rail; a plurality of stationary electromagnets mounted in the guide rail; and a carriage having a plurality of wheels configured to travel along the guide rail. The wheels are magnets. Movement of the carriage along the guide rail is brought about by a fluctuating magnetic field generated by the stationary electromagnets acting on the wheels.

### TECHNICAL FIELD

The invention relates to a rail system which can be used to move an object or load such as a panel, pedestrian or vehicular access doors, fixed and sectional panels, roller doors, curtains, and the like.

### BACKGROUND

Modern use of sectional and roller doors often incorporate an automated method of opening and closing for safety, convenience and efficiency. These automation methods often rely on wound spring or counterweight assisted winching systems using a geared rotating motor with cables and/or chains.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

According to the present disclosure, there is provided a rail system comprising:

a guide rail;

a plurality of stationary electromagnets mounted in the guide rail; and

a carriage having a plurality of wheels configured to travel along the guide rail;

wherein the wheels are magnets, and

wherein movement of the carriage along the guide rail is brought about by a fluctuating magnetic field generated by the stationary electromagnets acting on the wheels. The carriage may be configured for attachment to a load or an object.

The rail system may comprise a plurality of the guide rails and a plurality of the carriages. The plurality of guide rails may include a first guide rail and a second guide rail, the first guide rail and the second guide rail being space apart. The plurality of carriages may include one carriage mounted on the first guide rail and one carriage mounted on the second guide rail. The load may be attached to the one carriage on the first guide rail and to the one carriage on the second guide rail. The load may be moved by coordinated movement of the carriage on the first guide rail and the carriage on the second guide rail.

More than one carriage may be mounted on the first guide rail. The load may be attached to each carriage on the first guide rail. More than one carriage may be mounted on the second guide rail. The load may be attached to each carriage on the second guide rail.

Each guide rail may comprise a brake engaging surface. At least one carriage mounted on each guide rail may include a brake having a shape configured to engage the brake engaging surface. When there is more than one carriage mounted on each guide rail, each carriage may include a brake having a shape configured to engage the brake engaging surface of its associated guide rail. The brake of the carriage may engage the brake engaging surface of the guide rail to limit movement of the carriage when power supply to the electromagnets is interrupted.

The brake engaging surface may have a serrated profile. The brake of the carriage may have a matching serrated profile configured to engage positively with the brake engaging surface of the guide rail. The brake of the carriage may be in the form of a cam and the cam may have a serrated braking surface or foot associated therewith.

Once the brake of the carriage and the brake engaging surface of the guide rail are engaged to limit the movement of the carriage, release of the engagement may be brought about by movement of the brake in a direction opposite to the movement which brought about the engagement. For example, if downward movement of the carriage brings about engagement of the brake and the brake engaging surface, upward movement of the carriage releases the engagement of the brake and the brake engaging surface.

The load may be an object. The load may be a panel. In the following, the term “panel” is used to refer to a range of architectural structures suitable for closing or covering an opening in a building such as those for pedestrian and/or vehicular access.

The rail system may further comprise the load or panel. In the present disclosure, various terms including “panel” have been used to refer to a range of architectural structures suitable for closing or covering an opening in a building such as those for pedestrian and/or vehicular access and suitable for movement by the guide rail system. For example, terms such as curtain, door, roller door, sectional panel door, full panel door, solid panel door, garage door, and the like have been used. For simplicity, in the present disclosure, the term “panel” has also been used generally and inclusively to refer to these and similar architectural structures collectively. It will be appreciated that the carriage may be configured for attachment to objects or loads other than panels. The carriage may be configured for attachment to objects or containers into which objects can be placed. The rail system may be configured to transport or distribute the objects or the containers from one place to another.

The system may include a control system in order to control the provision of energy to the electromagnets. The control system may be powered by an external power source. A backup battery may also be provided to supply backup power in an emergency or to provide bulk power during operations to move the panel.

According to the present disclosure, there is provided a method of operating (e.g., opening and closing) such panels (such as, for example, doors) by incorporating a lifting mechanism into guide rails, which are a common component of automatic solid or sectional panel, roller door or curtain. The lifting mechanism includes the plurality of stationary electromagnets mounted in the guide rail and the plurality of wheels (being magnets) of the carriages.

According to the present disclosure, such an arrangement may allow for a reduction in installation components, and therefore installation time. It may lower maintenance costs and it may allow for quiet operation, as well as improved aesthetics.

According to an embodiment, the invention includes a fail-safe mechanism in the form of a braking system which operates in the event of a component failure or a disruption to electricity supplies. Such a system may enhance safety.

The rail system may be configured to lift a load or panel vertically. For example, a pair of guide rails may be arranged vertically and a panel may extend vertically between them. Movement of the carriages along the pair of guide rails may raise the panel vertically or lower the panel vertically. The system may be configured to move a load or panel in a horizontal direction. For example, a pair of guide rails may be arranged horizontally and a panel may extend between them. Movement of the carriages along the pair of guide rails may move the panel horizontally. The system may be configured to combine guide rails with vertical and horizontal portions and movement of the carriages along these respective portions will move the panel accordingly. It will be appreciated that the rail system is not limited only to vertical and horizontal configurations and that guide rails could be arranged at angles with respect to the vertical or horizontal planes in order to arrange a system that could move the panel in any direction.

Embodiments disclosed herein may be applicable to domestic, commercial and industrial applications with scale-able design to match weights, travel speeds and environments which vary dependent on application.

### BRIEF DESCRIPTION OF DRAWINGS

FIG. 1 is a schematic cross sectional view of a guide rail according to an embodiment of the present disclosure.

FIGS. 2A to 2B are schematic views of a guide rail according to an embodiment of the present disclosure in which the guide rail has a bent configuration.

FIGS. 3A to 3B are schematic views of a guide rail according to an embodiment of the present disclosure in which the guide rail has a straight configuration.

FIG. 4 is a schematic side view of a carriage according to an embodiment of the present disclosure.

FIGS. 5A and 5B are schematic cross-sectional views of a guide rail and carriage according to an embodiment of the present disclosure.

FIG. 6 is a schematic diagram of the control logic of components of a guide rail system according to an embodiment of the present disclosure.

### DESCRIPTION OF EMBODIMENTS

According to an embodiment, there is provided a rail system (or assembly) for the positioning and movement of a load (or object) such as a panel (for example, single and sectional panel doors, roller doors or curtains) in the vertical plane, the horizontal plane or in other planes at angles with respect to the vertical and horizontal planes. The rail system incorporates a magnetic drive and positioning system. The rail system includes at least one guide rail and at least one carriage. Each guide rail incorporates a series of electromagnet arrays (stationary electromagnets) which are positioned in the guide rail to provide magnetic attraction and repulsion in a sequential manner which will cause the carriage incorporating permanent magnets to move along the guide rail with variable force and speed dependent on instructions from a control system.

According to an embodiment, there is provided a carriage incorporating permanent magnets which form wheels. The carriage may be configured to connect to a load or an object. For example, in an embodiment, the load (or object) is in the form of a panel, a roller door, or the like. The carriage is mounted on the guide rail and driven via the electromagnets incorporated into the guide rail. The load may be positioned or moved via interaction of the wheels of the carriage and the electromagnets in the guide rail.

According to an embodiment, the rail system includes an integrated automatic mechanically operated braking system capable of maintaining the carriage and thereby the load or object (panel, roller door, or the like) in a fixed position in the absence of specific operations of the rail system or a disruption to electricity supplies. This braking system ensures that the load or object remains in any position intended without the requirement for constant drive signals and prevents movement in any direction if power should fail. For example, in the case where the load is a roller door, the braking system ensures that the roller door remains in any position intended without the requirement for constant drive signals and prevents movement of the roller door in any direction if power to the door control or drive system fails. In the event of an emergency, the system can be manually over-ridden and allow movement of the carriages and allow opening of the roller door.

Where the load is a door, for example, the rail system may be suitable for many panel materials and may be adaptable to varying widths and heights of panels, roller doors, curtains, and the like.

According to an embodiment, the rail system is component based with selection and quantity of components based on the particular application. Components can be manufactured at scale, that being physical characteristics other than size can remain consistent through light, medium and heavy-duty versions of the system. Force capacity is not particularly limited and can be set according to the particular application. For example and without intending to limit the scope of this disclosure, it may range from 500 to 4000 newtons. Operational speeds may also vary depending on the particular application and, by way of a non-limiting example, they may range from 0.1 to 4 metres per second.

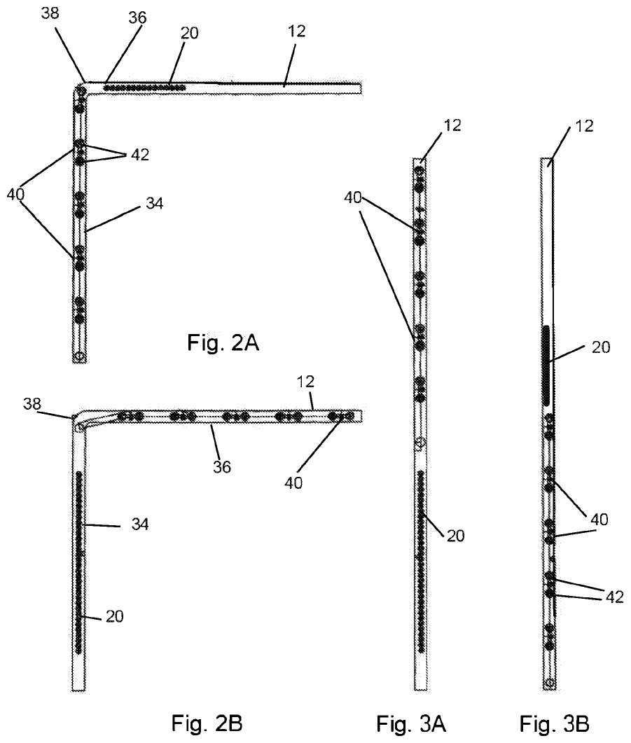

According to an embodiment, the rail system includes a pair of guide rails which are spaced apart such that the distance between the guide rails along their length is constant. The guide rails may be straight or curved or a combination thereof depending on the application and location. The guide rails may include straight sections connected by curved sections or bends. For example, a straight section which extends vertically may be connected to a straight section which extends horizontally connected by a bend (see, for example, FIGS. 2A and 2B). Carriages which are fixed to the moveable panel or curtain are attached in numbers required for the application and inserted onto the guide rails.

According to an embodiment, the rail system may include a single guide rail arranged substantially in one plane (for example, arranged substantially horizontally). For example, the rail system may be configured for moving a curtain and the rail system may be arranged above a window, a door opening or along a ceiling. In such cases, the guide rail may include straight sections, curved sections, or combinations thereof.

According to an embodiment, a control system which incorporates a battery back-up is installed adjacent to the guide rail(s) to provide controlled energy to the guide rail electromagnets which are electrified at varying currents and sequences to initiate movement of the carriages.

According to an embodiment, each carriage has a linkage, bracket, point of attachment, or the like (referred to below as linkage) which is configure for connection to the load or object.

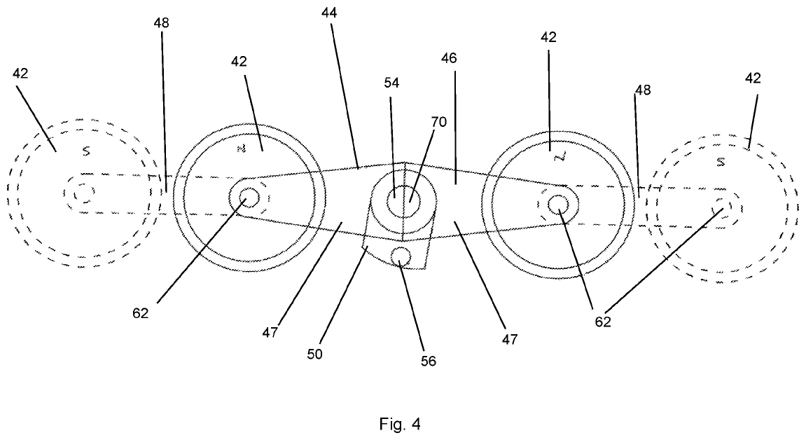

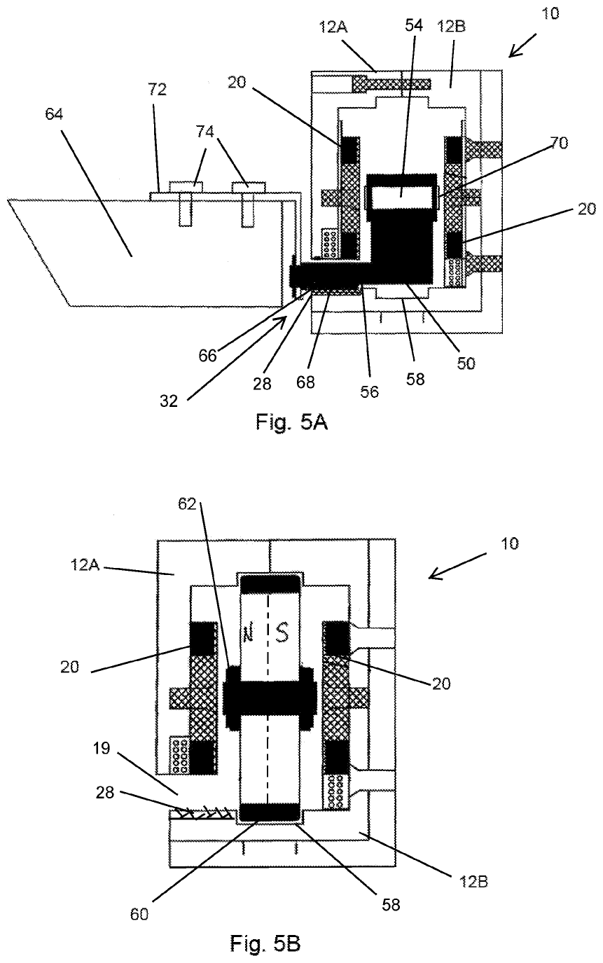

According to an embodiment, each carriage incorporates a brake mechanism which engages the guide rail during braking. For example, the brake mechanism may be in the form of a serrated cam feature that engages positively with a matching brake engaging surface in the form of a serrated profile incorporated into the guide rail (see FIGS. 4, 5A and 5B). The brake mechanism of the carriage may be provided on the linkage. For example, with respect to vertical configurations shown in FIGS. 3A and 3B, when a panel connected to a carriage attempts to move in a downward direction without a direct force from the carriage, the serrated cam feature engages with the brake engaging surface of the guide rail to cease any downward movement. According to this embodiment, only when an upward force is applied to the linkage by the carriage will the cam disengage. This ensures that there is no uninstructed downward movement of the load (e.g., the panel or curtain). In the event of an obstruction occurring to the downward movement of the load (e.g., the panel or curtain), the serrated cam feature will engage the serrated profile on the guide rail preventing further travel.

According to an embodiment, in order to enable travel in the downward direction (see for example, the configuration shown in FIGS. 3A and 3B), the carriages will be initially moved in the upward direction to disengage the cam braking mechanism and the speed of travel will be regulated in such a way that whilst under instruction the cam locks (braking mechanism) remain disengaged.

According to an embodiment, a system of electronics housed in the control unit uses current sensing and power loops to provide precise energization of the stator electromagnets (stationary magnets) which induce infinitely variable movements in the carriage fixed magnets. Using a loop feedback system, each guide rail and the carriages travelling upon it can be precisely located to avoid any misalignment of the load, panel or curtain and can maintain relative positioning at any point of travel.

According to an embodiment, the electronic control system has a self-calibration system which takes into account anomalies such as external factors such and wind, ice and other factors as well as friction variables due to age and maintenance. In this embodiment, a non-volatile memory of events and parameters forms part of the control system in order to provide service history and produce alarms and service requests via a basic display.

According to an embodiment, integrated dry contact triggering as well as on-board RF and Bluetooth communication provide several external control and monitoring solutions to the user of the system.

According to an embodiment, the control and operating system is designed for operation on a 24 volt DC external supply, where the size of the supply is dependent on the operating frequency of the system and the size of the unit (small, medium or large model).

In the following, embodiments are described with reference to the drawings.

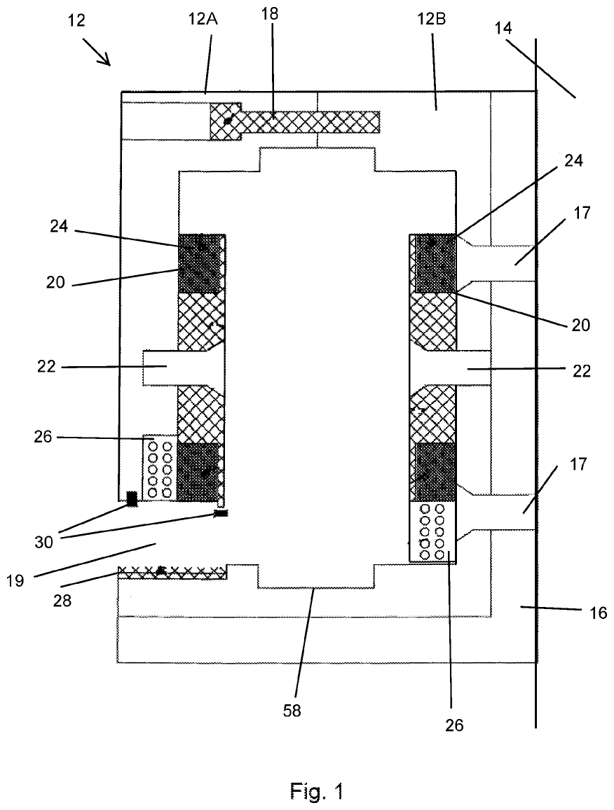

FIG. 1 shows a cross-section through an embodiment of a guide rail 12 of a rail system 10. In this embodiment, the guide rail 12 is fixed to the accommodating structure (for example, a wall) 14 via an “L” bracket 16 which permits attachment via screws 17 on the same or a perpendicular plane. The guide rail 12 is made up of two guide rail sections 12A and 12B which are made of non-ferrous metal or polymer and are joined via screws 18 arranged at prescribed intervals along their length. In this embodiment, there is a gap or clearance 19 present between guide rail section 12A and guide rail section 12B on the side of the guide rail 12 opposite the accommodating structure 14. Electromagnets (stator magnets) 20 are formed from ferrous bobbins 22 which are attached to the guide rail sections 12A and 12B and which host electromagnetic stator coils in the form of copper induction coils 24 wound around the bobbins 22. Each coil 24 is connected through an embedded PCB backplane (not illustrated) which interconnects to other rail sections or final controls via a multi pin connector 26. A serrated braking profile 28 as well as nylon guide inserts 30 form part of a braking system 32. The guide rails 12 are produced in modular sections and can be connected end-to-end and dependent on their location within the travel range of the panel or curtain may contain many, some or no stator electromagnets as required by each application.

FIGS. 2A and 2B show an example of a configuration of a guide rail 12 in a rail system 10 for moving a garage door (not shown), for example, a sectional garage door comprising multiple panels. In such an arrangement, a second guide rail 12 (not illustrated) is provided on the opposite side of the door opening in a corresponding configuration. FIGS. 2A and 2B show a bent configuration with a first portion 34 of the guide rail 12 being vertical and a second portion 36 of the guide rail 12 being horizontal. The first portion 34 is connected to the second portion 36 via a bend 38. FIG. 2A schematically shows the arrangement of carriages 40 in the vertical first portion 34 as they would be for a garage door in a fully closed position and FIG. 2B shows the arrangement of carriages 40 in the horizontal second portion 36 as they would be for a garage door in a fully open arrangement. The guide rail 12 which incorporates the electromagnets 20 can be configured in a bent configuration (as shown in FIGS. 2A and 2B) or it can be configured in a straight configuration (see FIGS. 3A and 3B). FIGS. 2A, 2B, 3A and 3B indicate indicative positions and size of electromagnets embedded in the guide rail 12 and representations of carriages 40 including permanent magnets in the form of wheels 42, showing fully closed (FIGS. 2A and 3B) and fully open positions (FIGS. 2B and 3A). Note that these Figures show cut away views showing examples and they are non-specific as to location and quantity of coils (electromagnets) and/or carriages. Where the guide rail 12 is bent (as in FIGS. 2A and 2B), the bend 38 may be a standard component fitted in between standard guide rails 12 which guide the carriages and maintain the electrical circuits.

FIG. 4 shows a schematic side view of a carriage. According to this embodiment, the rotor function of the rail system includes magnets in the form of circular rare earth high strength magnets which are also function as wheels 42 of the carriage 40. Depending on application, additional magnets (wheels) 42 may be added to the carriage 40. The wheels 42 are connected by a dolly 44 which includes a main connector 46 and extension arms 48. The main connector 46 and extension arms 48 are formed from non-ferrous material and connected using pin and clip arrangements 62 which also connect to the wheels 42. The extension arms 48 and additional wheels 42 are shown in dashed lines to indicate that they may be optional and included to increase the size and carrying capacity of the carriage 40. Further extension arms 48 and wheels 42 (not shown in the Figures) can be added to further increase the length and carrying capacity of the carriage 40. The main connector 46 includes connecting plates 47 and incorporates a cam 50 as part of the braking system 32 and a keyed central pin 54. The cam 50 may be configured for attachment to the load or object 64 (a garage door in this embodiment) to be moved by the rail system 10 by having a point of attachment, a bracket, linkage, or connector to which the load or object is attached. In this embodiment, the cam 50 includes a rod 56 which extends from the cam 50 through the gap 19 between guide rail sections 12A and 12B.

FIG. 5 shows schematic cross-sections of the guide rail 12 according to an embodiment. FIG. 5A shows a cross section through the guide rail 12 and the cam 50 of the main connector 46 of the dolly 44 of the carriage 40 (but does not show the connecting plates 47). FIG. 5B shows a cross section through the guide rail 12 and a wheel 42 of a carriage 40. The magnets (rare earth magnets in this embodiment) which form the wheels 42 of the carriage 40 are arranged such that the poles of the magnet interact with the electromagnetic stators 20 on the guide rail. The magnet wheels 42 are sized in accordance with the application and the size of the load to be moved by the rail system 10 and the guide rails 12, magnet wheels 42, etc. may be configured for small, medium and large loads. The wheels 42 are guided by a groove 58 which is formed in the guide rail 12. The wheels 42 may have a nylon outer ring 60 dependent on the application. The wheels 42 are held by a non-ferrous pin and clip arrangement 62. The main connector 46 incorporates the rigid rod 56 for attachment of the load or object 64 (e.g., roller door, door, curtain, etc.), a cam shaped casting 50 as the body incorporating the cam mechanism and a braking foot 66 formed on the rod 56 which has a serrated profile 68 which corresponds to and matches the serrated braking profile 28 on the guide rail 12. The main connector 46 is connected to the cam 50 by a large pin and clip arrangement 70. Connection to the load 64 is via a specific bracket 72 suited to the particular application. In this embodiment, the bracket 72 is connected at one end to the rod 56 and to the load 64 by screws 74. The central pin 54 rotates the cam 50 through several degrees dependent on load of the object 64 connected to the carriage via the rod 56. As a result, when the load of the object (e.g., the garage door) 64 bears on the carriage 40 under normal operation, the cam 50 is rotated and the rod 56 is positioned such that the braking foot 66 of the carriage 40 and the serrated braking profile 28 on the guide rail 12 are not engaged and the carriage 40 is movable relative to the guide rail. However, if, due to a malfunction, the carriage is not supporting (or bearing) the load of the object (for example, both carriage and object are falling together without resistance) the cam 50 rotates in the opposite direction and the rod 56 is positioned such that the braking foot 66 of the carriage 40 and the serrated braking profile 28 of the guide rail 12 engage and thereby act to prevent movement of both the carriage 40 and the object 64 relative to the guide rail 12.

It will be appreciated that in order to maintain the efficiency of the magnetic interaction between the electromagnets in the guide rails and the permanent magnets of the wheels, the use of non-ferrous or non-magnetic materials for other components (e.g., guide rails 12, connector plates 47, pins, clips, screws, and the like) of the system is preferred.

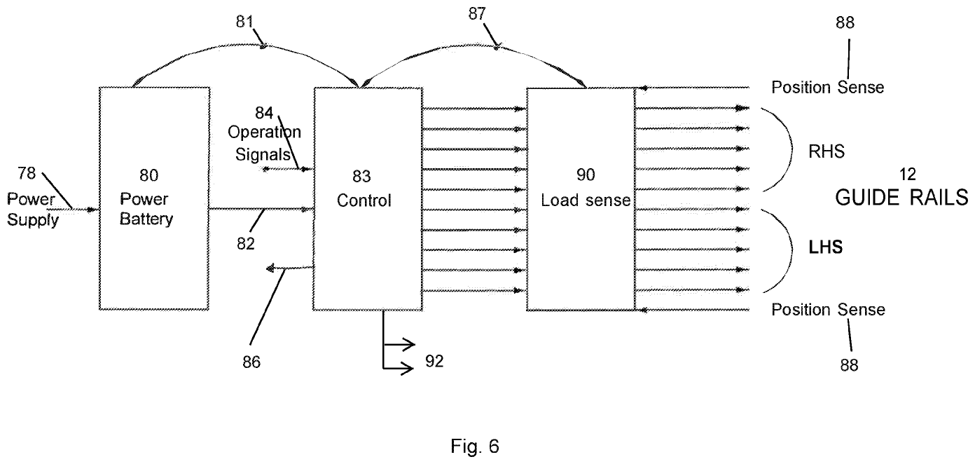

FIG. 6 shows a schematic diagram of an embodiment of the control logic of the electronic drivers and controls. In this embodiment, the operation of the rail system 10 is controlled by an electronic control system 76 in order to deliver power to the stators 20 in order to ensure smooth travel of the load 64 (panel, door, curtain, or the like). This can be affected by environmental factors, physical interference and power fluctuations. In this embodiment, the control system 76 is powered by an external 24 volt power source 78 which is sized based on the size and duty of the rail system installation. A battery 80 is installed to provide power as back-up power 81 in an emergency and bulk power 82 during operation of the rail system's mechanisms. A control circuit 83 will receive external operation signals 84 which include dry contact inputs, RF signals (remote control), or the like. On-board Bluetooth® connectivity 86 for control and monitoring functions is also possible.

In this embodiment, the control system 76 will provide electrical energy to groups of the stationary electromagnets (electromagnetic coils) 20 in the guide rails 12 in specific sequences and variable energy levels to generate fluctuating magnetic fields which act on the magnet wheels 42 of the carriage such that the carriage 40 moves along the guide rail 12 and thereby the load 64 connected to the carriage 40 is moved. In configurations in which a pair of guide rails 12 are used to move a load 64 (such as in the example of a garage door described above), a constant feedback loop 86 compares energy consumption in corresponding sections of each guide rail 12 to ensure that corresponding carriages 40 in each guide rail 12 are performing in unison. An additional pulse counter may also provide positional data from position sensing 88 and load data from load sensing 90 associated with each guide rail 12 to provide positional, load, speed and alert signals. In FIG. 6, the guide rails 12 are designated “LHS” for left hand side guide rail 12 and “RHS” for right hand side guide rail 12. The control system 76 includes a programmed calibration sequence which is used for initial set-up and may also run routinely or when parameters are sensed which fall outside of operational set points or in the event of interrupted or impeded operation. A solenoid activated lock mechanism 92 may be provided to prevent manual movement of the load 64 (for example, raising of a garage door, movement of a panel or curtain).

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1-8. (canceled)

9. A rail system comprising:
a guide rail;
a plurality of stationary electromagnets mounted in the guide rail; and
a carriage having a plurality of wheels configured to travel along the guide rail;
wherein the wheels are magnets; and
wherein movement of the carriage along the guide rail is brought about by a fluctuating magnetic field generated by the stationary electromagnets acting on the wheels.

10. A rail system according to claim 9, wherein the carriage is configured for attachment of a load such that movement of the carriage along the guide rail moves the load.

11. A rail system according to claim 10, further comprising:
a plurality of the guide rails and a plurality of the carriages;
wherein the plurality of guide rails includes a first guide rail and a second guide rail, the first guide rail and the second guide rail being space apart;
the plurality of carriages includes one carriage mounted on the first guide rail and one carriage mounted on the second guide rail; and
the load is attached to the one carriage on the first guide rail and to the one carriage on the second guide rail; and
the load is moved by coordinated movement of the carriage on the first guide rail and the carriage on the second guide rail.

12. A rail system according to claim 11, wherein
each guide rail comprises a brake engaging surface, and
at least one carriage mounted on each guide rail includes a brake having a shape configured to engage the brake engaging surface,
wherein the brake engages the brake engaging surface of the guide rail to limit movement of the carriage when power supply to the electromagnets is interrupted.

13. A rail system according to claim 12, further comprising the load.

14. A rail system according to claim 13, wherein the load is one of a panel and a door.

15. A rail system according to claim 14, wherein the first guide rail and the second guide rail are aligned at an angle with respect to a horizontal plane such that movement of the carriages along the first guide rail and the second guide rail raises or lowers the load with respect to the horizontal plane.

16. A rail system according to claim 13, wherein the first guide rail and the second guide rail are aligned at an angle with respect to a horizontal plane such that movement of the carriages along the first guide rail and the second guide rail raises or lowers the load with respect to the horizontal plane.

17. A rail system according to claim 12, wherein the load is one of a panel and a door.

18. A rail system according to claim 12, wherein the first guide rail and the second guide rail are aligned at an angle with respect to a horizontal plane such that movement of the carriages along the first guide rail and the second guide rail raises or lowers the load with respect to the horizontal plane.

19. A rail system according to claim 11, further comprising the load.

20. A rail system according to claim 11, wherein the load is one of a panel and a door.

21. A rail system according to claim 11, wherein the first guide rail and the second guide rail are aligned at an angle with respect to a horizontal plane such that movement of the carriages along the first guide rail and the second guide rail raises or lowers the load with respect to the horizontal plane.

22. A rail system according to claim 10, wherein
each guide rail comprises a brake engaging surface, and
at least one carriage mounted on each guide rail includes a brake having a shape configured to engage the brake engaging surface,
wherein the brake engages the brake engaging surface of the guide rail to limit movement of the carriage when power supply to the electromagnets is interrupted.

23. A rail system according to claim 10, further comprising the load.

24. A rail system according to claim 10, wherein the load is one of a panel and a door.

25. A rail system according to claim 9, wherein
each guide rail comprises a brake engaging surface, and
at least one carriage mounted on each guide rail includes a brake having a shape configured to engage the brake engaging surface,
wherein the brake engages the brake engaging surface of the guide rail to limit movement of the carriage when power supply to the electromagnets is interrupted.
